(19) United States
(12) Patent Application Publication
(10) Pub. No.: US 2018/0257850 A1
(43) Pub. Date: Sep. 13, 2018

(54) FROZEN ITEM HOLDING DEVICE

(71) Applicants: Linda M. Bastian, CrossLake, MN (US); Kenneth Bastian, Crosslake, MN (US)

(72) Inventors: Linda M. Bastian, CrossLake, MN (US); Kenneth Bastian, Crosslake, MN (US)

(21) Appl. No.: 15/919,001

(22) Filed: Mar. 12, 2018

Related U.S. Application Data
(60) Provisional application No. 62/470,145, filed on Mar. 10, 2017.

(51) Int. Cl. B65D 85/60; A23G 9/50

(52) U.S. Cl. CPC B65D 85/60; A23G 9/503

(57) ABSTRACT

A device for holding at least one frozen-item; the device includes a body, and a flap. The body includes an inner-capacity defined by a body-shell, a substantially open-end and a substantially closed-end opposite the substantially open-end and has a neoprene material configured to provide insulation and moisture-absorption. The flap is configured to substantially seal the substantially closed-end. The device is useful for holding at least one frozen item therein to prevent uncomfortable contact of the frozen item with a users' skin.

### CROSS REFERENCE TO RELATED APPLICATION

The present application is related to and claims priority to U.S. Provisional Patent Application No. 62/470,145 filed Mar. 10, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of receptacles and more specifically relates to a receptacle for holding at least one frozen-item therein.

### 2. DESCRIPTION OF RELATED ART

Many individuals enjoy frozen food items, such as freeze pops, yogurt sticks, and frozen juice bars or even frozen teething rings, however there are many issues that make it very hard for children and adults to fully enjoy the frozen items. Children are especially fond of frozen treats. It can be difficult for children to hold onto the frozen item when eating it due to the contact with the cold exterior. Many children, and even adults, find the discomfort to be too much and they often discard the item early or simply set it down. This can result in a mess as the item melts and is unnecessarily wasteful. Wrapping a paper towel around the item can help to diminish the cold sensation, however the paper often becomes saturated due to the moisture. A more effective alternative is needed.

U.S. Pub. No. 2005/0281928 to Loretta Crowley relates to an insulative, pliable frozen treat receptacle and method. The described insulative, pliable frozen treat receptacle and method includes a first wall panel coupled to a second wall panel to define a pocket with an open inner volume and an open mouth. The panels can be coupled by a unitary formation of the wall panels, by adhesive, by heat sealing, by sewing, or by any other effective arrangement. The wall panels can be formed from an insulative material, such as resiliently compressible closed cell foam material. The wall panels can be rectangular and substantially similar in size and shape and can have widths of approximately 2 and ½ inches, lengths of approximately 4 and ¾ inches, and thicknesses of approximately 2 mm The frozen treat receptacle can be capable of being removably and replaceably coupled to an external structure, such as by hook and loop material.

BRIEF SUMMARY OF THE INVENTION

In view of the foregoing disadvantages inherent in the known receptacles art, the present disclosure provides a novel frozen item holding device, entitled ‘FREEZE SLEEVE’. The general purpose of the present disclosure, which will be described subsequently in greater detail, is to provide a receptacle for holding at least one frozen item therein to prevent uncomfortable contact of the frozen item with a users' skin.

A device is disclosed herein. The device includes a body which may include an inner-capacity being defined by a body-shell, a substantially open-end and a substantially closed-end opposite the substantially open-end. The body-shell may be made from an insulative-material and include an inner-surface and an outer-surface. The inner-capacity may be configured to hold the at least one frozen-item. Further, a flap may be attached to the body-shell and configured to substantially seal the substantially closed-end.

A method of using device is also disclosed herein. The method of using device may comprise the steps of: providing the device as above; sliding the at least one frozen-item into the inner-capacity of the body via the substantially open-end; consuming (using up) the at least one frozen-item; and using the flap to aid in advancing the at least one frozen-item from the substantially-closed end to the substantially-open end.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a frozen item holding device, constructed and operative according to the teachings of the present disclosure.

FIG. 1 is a front perspective view of the device during an ‘in-use’ condition, according to an embodiment of the disclosure.

FIG. 2 is a front perspective view of the device of FIG. 1, according to an embodiment of the present disclosure.

FIG. 3 is a front perspective view of the device of FIG. 1, according to an embodiment of the present disclosure.

FIG. 4 is a front perspective view of the device of FIG. 1, according to an embodiment of the present disclosure.

FIG. 5 is a flow diagram illustrating a method of use for the device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to receptacles and more particularly to a frozen item holding device as used to improve the efficiency and comfortable use of receptacles for holding at least one frozen-item therein.

Generally, disclosed is a device which may be made from neoprene and designed to wrap around a frozen food item, such as a freeze pop, ice cream cup, juice bar, yogurt stick or the like. The device may eliminate the discomfort associated with holding a frozen item and absorbs moisture as the product melts. It may prevent children from losing interest in their food and prematurely discarding it due to discomfort. Further, the device may offer a customizable kit to allow users to design and decorate their own insulated sleeve. The present device may allow children and adults to comfortably hold a frozen item for a longer period of time.

The device may include an insulated sleeve designed to provide comfort when holding a frozen food item, such as a freeze pop. The sleeve may be comprised of a slender piece of neoprene in a tubular shape. The freeze pop (yogurt stick, or other item) may slide into the sleeve. A small flap may be included to keep the item from falling out and can also assist users in advancing the product during consumption. The sleeve may also be available in a smaller version designed for small cups of ice cream. Additionally, the sleeve may also be available as a wrap with a hook and loop fastener to wrap around various shaped and sized teething rings that can be frozen.

The sleeves may be available in a wide variety of bright colors, including neon, and patterns. Further, as above, the kit may be available that allows users to decorate their own sleeve using colors, gems, studs, stamps, and more. Holders designed to hold the frozen item upright may be included. These holders may be available in a variety of different characters and sizes and shapes (oval, round, various shaped to shape of frozen product). Male and female gender characters may be used as a holder of the ‘wrapped product’ for example princesses or super heroes or the like. In this way the freeze pop for example may replicate a princess as held. Sports teams or cartoon-themed or the like may comprise the holder. The holder may comprise indicia (logos, etc). The exact specifications may vary.

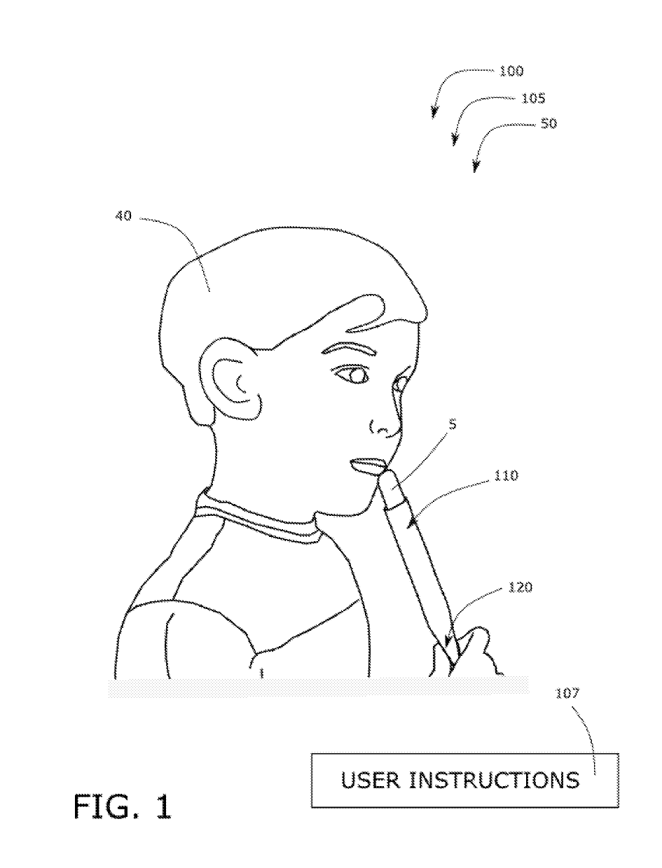

Referring now more specifically to the drawings by numerals of reference, there is shown in FIGS. 1-5, various views of a device 100.

FIG. 1 shows a device 100 during an ‘in-use’ condition 150, according to an embodiment of the present disclosure. As illustrated, the device 100 may include a body 110 and a flap 120. The device 100 may be used for holding at least one frozen-item 5. In this figure, the at least one frozen-item 5 is shown to be an ice-pop.

According to one embodiment, the device 100 may be arranged as a kit 105. The kit 105 may include set of user instructions 107. The instructions 107 may detail functional relationships in relation to the structure of the device 100 (such that the device 100 can be used, maintained, or the like, in a preferred manner).

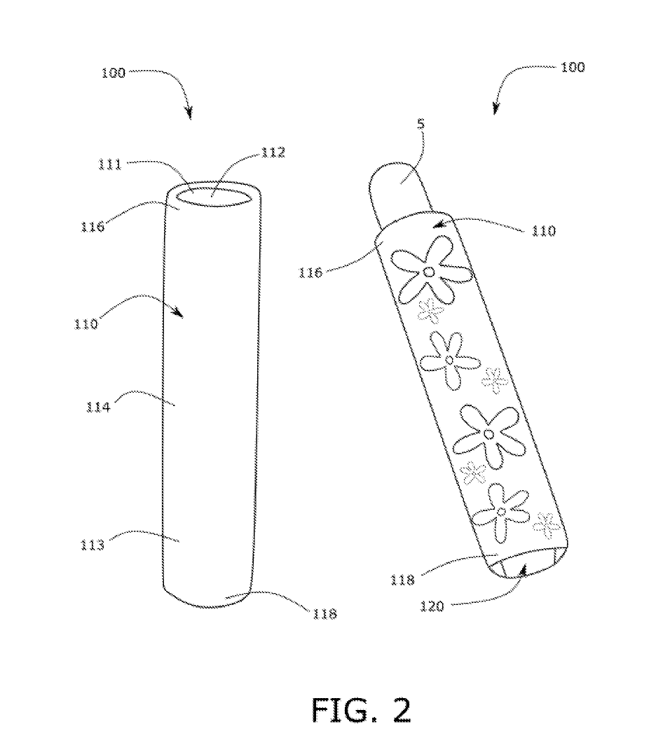

Referring now to FIG. 2 showing a front perspective view of the device 100 of FIG. 1, according to an embodiment of the present disclosure. The body 110 may include an inner-capacity 112 being defined by a body-shell 114, a substantially open-end 116 and a substantially closed-end 118 opposite the substantially open-end 116. The body-shell 114 may be made from an insulative-material. The insulative-material may comprise a synthetic-rubber, and in a preferred embodiment, the synthetic-rubber may comprise neoprene. In one embodiment, the insulative-material may be a continuous-piece of material, including no seam or fastener. However, other embodiments are contemplated.

The neoprene material may be closed-cell to provide a waterproof ability, or open-cell to provide breathability to the material. The material may include a flexibility to allow the body 110 to accept the at least one frozen-item 5 of a plurality of sizes, and to in some embodiments, accommodate more than one frozen-item 5. The neoprene material may further be configured to absorb moisture released from the at least one frozen-item 5 to prevent the user 40 from being exposed to a cold moisture from the at least one frozen-item 5. Further, the insulative-material may comprise a thickness of at least 5 mm in order to provide enough insulation to prevent a temperature of the at least one frozen-item 5 from coming into contact with the user 40 and causing discomfort to the user 40.

Further, the body-shell 114 may include an inner-surface 111 and an outer-surface 113, and as shown, the inner-capacity 112 may be configured to hold the at least one frozen-item 5. The outer-surface 113 of the body-shell 114 may include a functional decorative-design provided for ready identification for a user 40. The functional decorative-design may comprise a variety of colors and designs. Examples of designs may include the users 40 name, brand logos, etc.

The flap 120 may be attached to the body-shell 114 and configured to substantially seal the substantially closed-end 118 to prevent the at least one frozen-item 5 from falling out of the substantially closed-end 118. The flap 120 may be used to advance the at least one frozen-item 5 through the substantially open-end 116 as the user 40 consumes the at least one frozen-item 5. As shown, in one embodiment, the at least one frozen-item 5 may be the ice-pop, and the inner-capacity 112 may be sized to receive the ice-pop. Further, in this embodiment, the body may comprise a tubular shape. In other embodiments, the flap 120 may be absent and the substantially closed-end 118 may be completely closed.

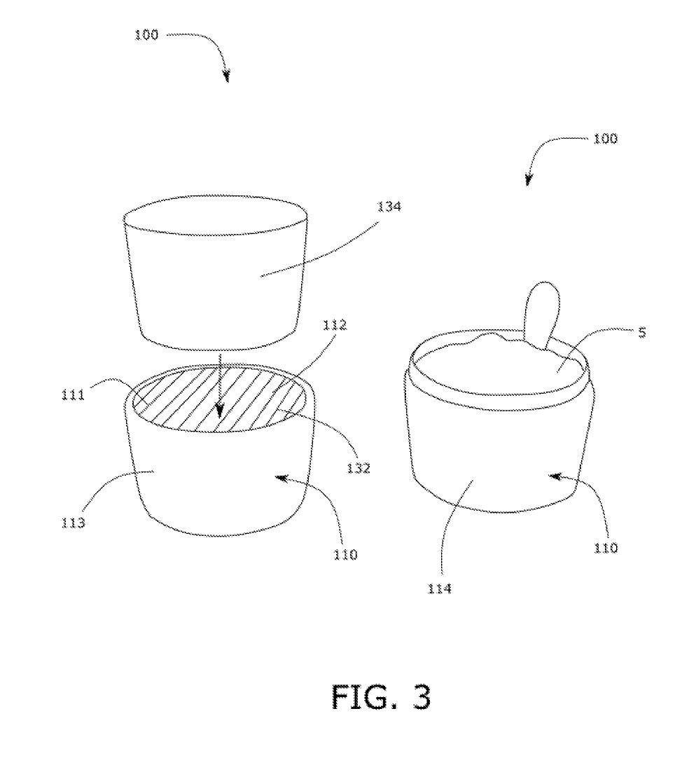

FIG. 3 shows a front perspective view of the device 100 of FIG. 1, according to an embodiment of the present disclosure. As shown here, the frozen-item 5 may be an ice-cream cup, and the inner-capacity 112 may be sized to receive the ice-cream cup. Further, in this embodiment, the body 110 may comprise a cylindrical shape configured to conform to a shape of the ice-cream cup. In one embodiment, the inner-surface 111 of the body-shell 114 may include a reflective-insulation material 132 (or radiant barrier). The reflective-insulation material 132 may prevent heat transfer to the at least one frozen-item 5, thus preventing premature melting or warming of the at least one frozen-item 5.

The device 100 may further comprise a rigid-layer 134 housed between the inner-surface 111 and the outer-surface 113 to provide stability to the body-shell 114. In one embodiment, the rigid-layer 134 may be made from a plastic-material, however other materials are contemplated such as paper, metal, etc. The rigid-layer 134 may allow the at least one frozen-item 5 to be held upright, and to provide support to the at least one frozen-item 5.

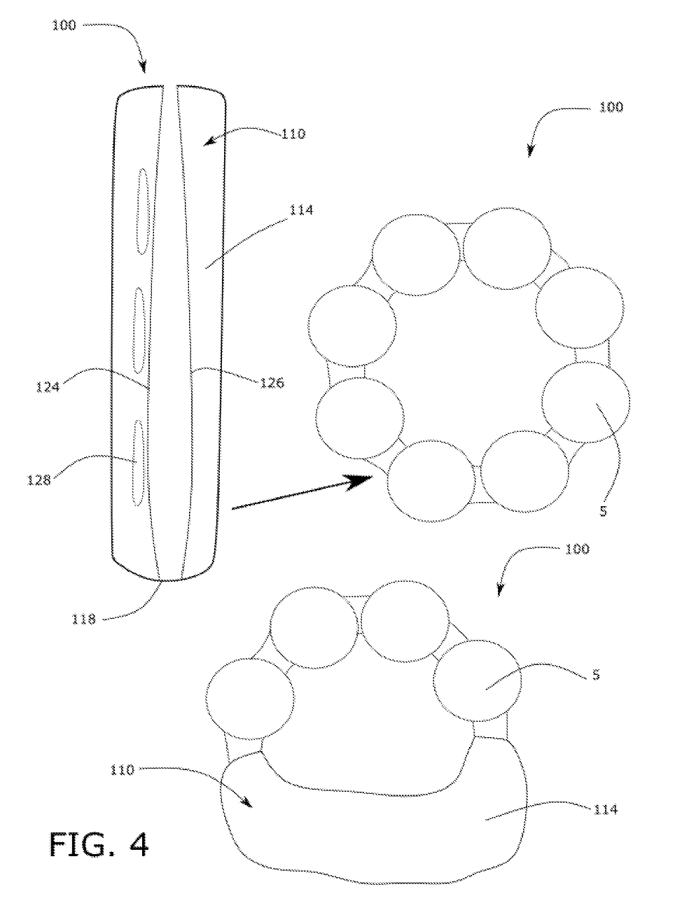

FIG. 4 shows a front perspective view of the device 100 of FIG. 1, according to an embodiment of the present disclosure. As above, the insulative-material may be the continuous-piece of material, including no seam or fastener (FIG. 2). In other embodiments, the insulative-material may include an opening and a fastening-means 128 such that the body may be wrapped around the at least one frozen-item 5 and secured via the fastening-means 128.

In this embodiment, the body-shell 114 may include a body-opening 122 between the substantially-open end and the substantially closed-end 118. As shown, the body-opening 122 may be defined by a first opening-side 124 and a second opening-side 126 opposite the first opening-side 124. Further, the first opening-side 124 and the second opening-side 126 may include the fastening-means 128 configured to close the body-opening 122.

In a preferred embodiment, the fastening-means 128 may be a hook and loop fastener, however other fastening-means 128 are contemplated such as snap-fasteners, hook and eye fasteners, buttons, etc. As illustrated in this figure, this embodiment may be particularly useful for frozen teething-rings. The body-shell 114 may be wrapped around the frozen teething-ring to define a section for the user 40 to hold and the body-shell 114 may then be secured in place via the fastening-means 128.

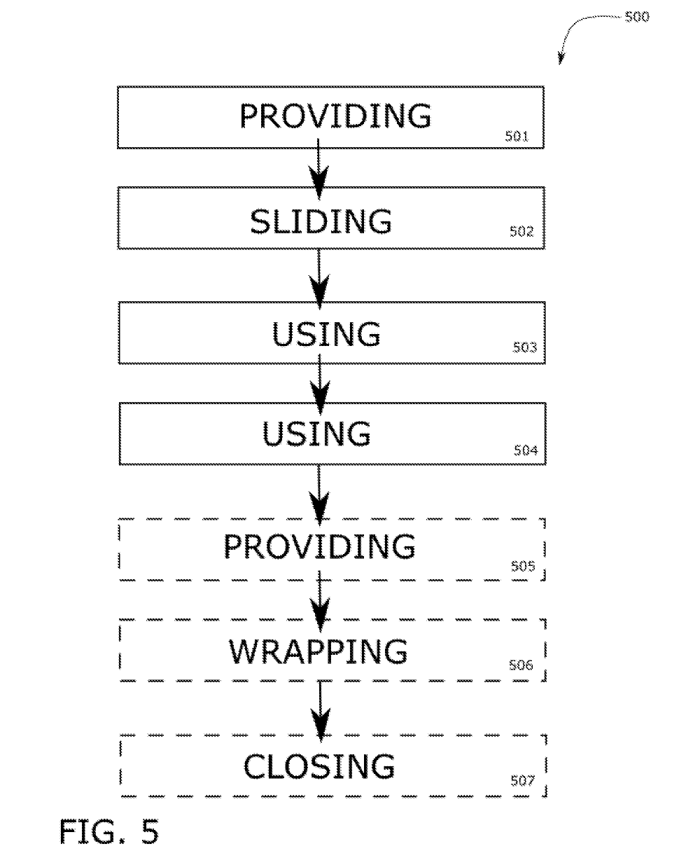

FIG. 5 is a flow diagram 550 illustrating a method of using a device for holding at least one frozen-item 500, according to an embodiment of the present disclosure. As illustrated, the method of using a device for holding at least one frozen-item 500 may include the steps of: step one 501, providing the device 100 as above; step two 502, sliding the at least one frozen-item 5 into the inner-capacity 112 of the body 110 via the substantially open-end 116; step three 503, consuming/using the at least one frozen-item 5; and step four 504, using the flap 120 to aid in advancing the at least one frozen-item 5 from the substantially closed-end 118 to the substantially open-end 116. Further steps may include: step five 505, providing the device 100 wherein the body further includes a body-opening 122 between the substantially-open end and the substantially closed-end 118, the body-opening 122 being defined by a first opening-side 124 and a second opening-side 126 opposite the first opening-side 124, and wherein the first opening-side 124 and the second opening-side 126 include fastening-means 128 configured to close the body-opening 122; step six 506, wrapping the body 110 around the at least one frozen-item 5; and step seven 507, closing the body-opening 122 via the fastening-means 128.

It should be noted that step five 505, step six 506 and step seven 507 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for device 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A device for holding at least one frozen-item, the device comprising:
a body including an inner-capacity being defined by a body-shell, a substantially open-end and a substantially closed-end opposite the substantially open-end, the body-shell being made from an insulative-material and including an inner-surface and an outer-surface, and wherein the inner-capacity is configured to hold the at least one frozen-item; and
a flap attached to the body-shell and configured to substantially seal the substantially closed-end.

2. The device of claim 1, wherein the insulative-material comprises a synthetic-rubber.

3. The device of claim 2, wherein the insulative-material comprises a thickness of at least 5 mm

4. The device of claim 3, wherein the synthetic-rubber comprises neoprene.

5. The device of claim 1, wherein the body-shell is made from the insulative-material, and wherein the insulative-material is a continuous-piece of material.

6. The device of claim 1, wherein the body-shell includes a body-opening between the substantially-open end and the substantially closed-end.

7. The device of claim 6, wherein body-opening is defined by a first opening-side and a second opening-side opposite the first opening-side, and wherein the first opening-side and the second opening-side include fastening-means configured to close the body-opening.

8. The device of claim 7, wherein the fastening-means is hook and loop fastener.

9. The device of claim 1, wherein the outer-surface of the body-shell includes a functional decorative-design provided for ready identification for a user.

10. The device of claim 1, wherein the inner-surface of the body-shell includes a reflective-insulation material.

11. The device of claim 1, further comprising a rigid-layer housed between the inner-surface and the outer-surface, and wherein the rigid-layer is configured to provide stability to the body-shell.

12. The device of claim 11, wherein the rigid-layer is made from a plastic-material.

13. The device of claim 1, wherein the body comprises a tubular shape.

14. The device of claim 1, wherein the body comprises a cylindrical shape.

15. The device of claim 1, wherein the frozen-item is an ice-pop, and the inner-capacity is sized to receive the ice-pop.

16. The device of claim 1, wherein the frozen-item is an ice-cream cup, and the inner-capacity is sized to receive the ice-cream cup.

17. A device for holding at least one frozen-item, the device comprising:
a body including an inner-capacity being defined by a body-shell, a substantially open-end and a substantially closed-end opposite the substantially open-end, the body-shell being made from an insulative-material and including an inner-surface and an outer-surface, and wherein the inner-capacity is configured to hold the at least one frozen-item; and
a flap attached to the body-shell and configured to substantially seal the substantially closed-end; and
wherein the insulative-material comprises a synthetic-rubber;
wherein the insulative-material comprises a thickness of at least 5 mm;
wherein the synthetic-rubber comprises neoprene;
wherein the body-shell is made from the insulative-material, and wherein the insulative-material is a continuous-piece of material;
wherein the outer-surface of the body-shell includes a functional decorative-design to provide identification means;
wherein the inner-surface of the body-shell includes a reflective-insulation material;
wherein the device further comprises a rigid-layer housed between the inner-surface and the outer-surface;
wherein the outer surface comprises a temperature greater than that of said inner-surface such that the outer surface less cool to touch during use; and
wherein the rigid-layer is configured to provide stability to the body-shell.

18. The device of claim 17, further comprising set of instructions; and
wherein the device is arranged as a kit.

19. A method of using a device for holding at least one frozen-item, the method comprising the steps of:
providing the device for holding the at least one frozen-item, the device including:
a body including an inner-capacity being defined by a body-shell, a substantially open-end and a substantially closed-end opposite the substantially open-end, the body-shell being made from an insulative-material and including an inner-surface and an outer-surface, and wherein the inner-capacity is configured to hold the at least one frozen-item; and
a flap attached to the body-shell and configured to substantially seal the substantially closed-end;
sliding the at least one frozen-item into the inner-capacity of the body via the substantially open-end;
consuming the at least one frozen-item; and
using the flap to aid in advancing the at least one frozen-item from the substantially-closed end to the substantially-open end.

20. The method of claim 19, further comprising the steps of:
providing the device wherein the body further includes a body-opening between the substantially-open end and the substantially closed-end, the body-opening being defined by a first opening-side and a second opening-side opposite the first opening-side, and wherein the first opening-side and the second opening-side include fastening-means configured to close the body-opening;
wrapping the body around the at least one frozen-item; and
closing the body-opening via the fastening-means.
